(19) United States
(12) Patent Application Publication
(10) Pub. No.: US 2015/0365339 A1
(43) Pub. Date: Dec. 17, 2015

(54) COUNTER WITH OVERFLOW FIFO AND A METHOD THEREOF

(71) Applicant: XPLIANT, Inc., San Jose, CA (US)

(72) Inventors: Weihuang Wang, Los Gatos, CA (US); Srinath Atluri, Fremont, CA (US)

(21) Appl. No.: 14/302,343

(22) Filed: Jun. 11, 2014

(51) Int. Cl. H04L 12/863; H04L 12/861

(52) U.S. Cl. CPC H04L 47/6245; H04L 49/9084

(57) ABSTRACT

Embodiments of the present invention relate to an architecture that extends counter life by provisioning each counter for an average case and handles overflow via an overflow FIFO and an interrupt to a process monitoring the counters. This architecture addresses a general optimization problem, which can be stated as, given N counters, for a certain CPU read interval T, of how to minimize the number of storage bits needed to store and operate these N counters. Equivalently, this general optimization problem can also be stated as, given N counters and a certain amount of storage bits, of how to optimize and increase CPU read interval T. This architecture extends the counter CPU read interval linearly with depth of the overflow FIFO.

### FIELD OF INVENTION

The present invention relates to counters in a high speed network switch. More particularly, the present invention relates to counter with overflow FIFO and a method thereof.

### BACKGROUND OF THE INVENTION

Statistics counters are used to perform data analytics in a high speed network device. To be useful, an architecture needs to store a large number of counters. Although off-chip DRAM (dynamic random access memory) can be used, it cannot accommodate high speed counter updates. On-chip SRAM (static random access memory) allows for greater speed but is very expensive. Since the memory is one of the most expensive resources in an SOC (system on chip), it is critical to efficiently and flexibly utilize the memory. When dealing with storing multiple counters, there exists a tradeoff between fewer larger counters or more smaller counters. Ideally, each counter is long enough to avoid integer overflow, the wrapping around of the counter. However, in standard practice, this leads to overprovisioning, assigning the worst case number of bits for all counters.

### BRIEF SUMMARY OF THE INVENTION

Embodiments of the present invention relate to an architecture that extends counter life by provisioning each counter for an average case and handles overflow via an overflow FIFO and an interrupt to a process monitoring the counters. This architecture addresses a general optimization problem, which can be stated as, given N counters, for a certain CPU read interval T, of how to minimize the number of storage bits needed to store and operate these N counters. Equivalently, this general optimization problem can also be stated as, given N counters and a certain amount of storage bits, of how to optimize and increase CPU read interval T. This architecture extends the counter CPU read interval linearly with depth of the overflow FIFO.

In one aspect, a counter architecture is provided. The counter architecture is typically implemented in a network device, such as a network switch. The counter architecture includes N wrap-around counters. Each of the N wrap-around counters is associated with a counter identification. In some embodiments, each of the N wrap-around counters is w-bits wide. In some embodiments, the N wrap-around counters are in an on-chip SRAM memory.

The counter architecture also includes an overflow FIFO that is used and shared by the N wrap-around counters. The overflow FIFO typically stores the associated counter identifications of all counters that are overflowing.

In some embodiments, the counter architecture also includes at least one interrupt sent to a CPU to read the overflow FIFO and one of the overflowed counters.

In some embodiments, in a timing interval T, a number of counter overflow is M=ceiling(EPS*T/2^{w}), wherein EPS is events per second, and w is the bit width of each counter. In some embodiments, EPS is packets per second for packet count. Alternatively, EPS is bytes per second for byte count.

In some embodiments, the overflow FIFO is M-deep and log₂N-bits wide to capture all counter overflows.

In some embodiments, the counter architecture requires w*N+M*log₂N total storage bits.

In another aspect, a method of a counter architecture is provided. The counter architecture includes at least one counter. The method includes incrementing a count in the at least one counter. Each of the at least one counter is typically associated with a counter identification. In some embodiments, the at least one counter is a wrap-around counter.

The method also includes, upon overflowing one of the at least one counter, storing the counter identification of the overflowed counter in a queue. In some embodiments, the queue is a FIFO buffer. In some embodiments, storing the counter identification in the queue sends interrupt to a CPU to read values from the queue and the overflowed counter.

In some embodiments, the method also includes calculating an actual value of the overflowed counter from the read values.

In some embodiments, the method also includes, after reading the overflowed counter, clearing the overflowed counter.

In yet another aspect, a method of a counter architecture is provided. The counter architecture includes a plurality of wrap-around counters. The method includes incrementing counts in the plurality of wrap-around counters. Typically, each of the plurality of counters is associated with a counter identification. The method also includes upon occurrence of an overflow of one of the plurality of wrap-around counters, storing the counter identification in an overflow FIFO, processing data at the head of the overflow FIFO, identifying a wrap-around counter by the data at the head of the overflow FIFO, reading a value stored in the identified wrap-around counter, and clearing the identified wrap-around counter.

In some embodiments, each of the plurality of wrap-around counters has the same width.

In some embodiments, the overflow FIFO is shared by the plurality of wrap-around counters.

In some embodiments, the counter architecture is implemented in a network device.

In some embodiments, the method includes repeating processing data, reading the overflow FIFO as long as it is not empty, identifying a wrap-around counter, reading a value and clearing the identified wrap-around counter.

In yet another aspect, a network device is provided. The network device includes a common memory pool. Typically, memories from the common memory pool are separated into a plurality of banks. The network device also includes a counter architecture for extending CPU read interval. The counter architecture includes N wrap-around counters that use at least a subset of the plurality of banks. Typically, each of the N wrap-around counters is associated with a counter identification. The counter also includes an overflow FIFO that stores associated counter identifications of all counters that wrap around.

In some embodiments, the network device also includes SRAM. The N wrap-around counters are stored in SRAM. In some embodiments, the overflow FIFO is stored in SRAM. Alternatively, the overflow FIFO is fixed function hardware.

In some embodiments, the network device also includes at least one interrupt sent to a CPU to read the overflow FIFO and to read and clear one of the N wrap-around counters.

In some embodiments, in a timing interval T, a number of counter overflow is M=ceiling(total_count_during_interval_T/2^{w}), wherein total_count_during_interval_T is determined by bandwidth of the network device, and w is the bit width of each counter. In some embodiments, the total_count_during_interval_T is PPS*T for packet count, wherein PPS is packets per second. In some embodiments, the total_count_during_interval_T is BPS*T for byte count, wherein BPS is bytes per second.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 illustrates a block diagram of a counter architecture according to an embodiment of the present invention.

FIG. 2 shows an exemplary w-versus-total storage bits graph exemplifying a general optimization problem.

FIG. 3 illustrates a method of a counter architecture according to an embodiment of the present invention.

### DETAILED DESCRIPTION OF THE INVENTION

In the following description, numerous details are set forth for purposes of explanation. However, one of ordinary skill in the art will realize that the invention can be practiced without the use of these specific details. Thus, the present invention is not intended to be limited to the embodiments shown but is to be accorded the widest scope consistent with the principles and features described herein.

Embodiments of the present invention relate to an architecture that extends counter life by provisioning each counter for an average case and handles overflow via an overflow FIFO and an interrupt to a process monitoring the counters. This architecture addresses a general optimization problem, which can be stated as, given N counters, for a certain CPU read interval T, of how to minimize the number of storage bits needed to store and operate these N counters. Equivalently, this general optimization problem can also be stated as, given N counters and a certain amount of storage bits, of how to optimize and increase CPU read interval T. This architecture extends the counter CPU read interval linearly with depth of the overflow FIFO.

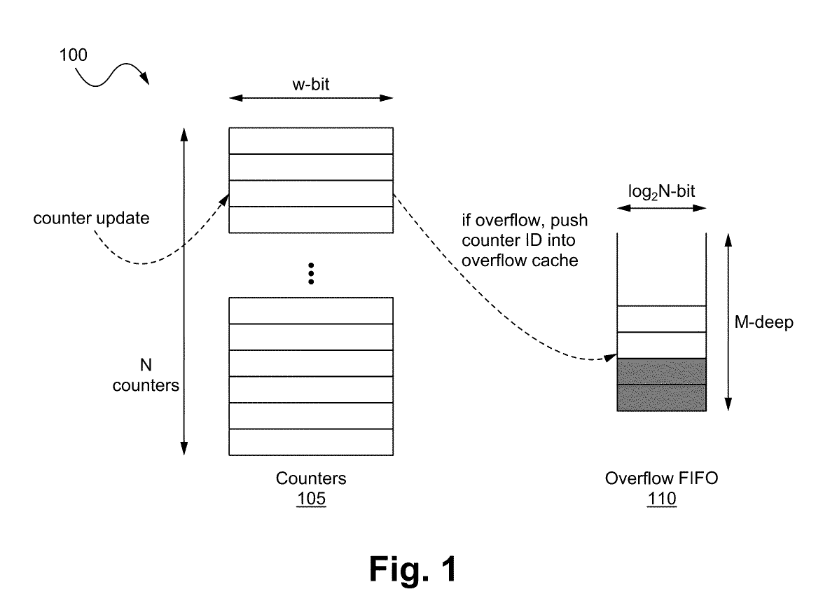

FIG. 1 illustrates a block diagram of a counter architecture 100 according to an embodiment of the present invention. The counter architecture 100 is implemented in a high speed network device, such as a network switch. The architecture 100 includes N wrap-around counters 105 and an overflow FIFO 110. Each of the N counters is w-bits wide and is associated with a counter identification. Typically, the counter identification is an unique identification of that counter. In some embodiments, the counters are stored in an on-chip SRAM memory, using two banks of memory. Exemplary counters and memory banks are discussed in U.S. patent application Ser. No. 14/289,533, entitled “Method and Apparatus for Flexible and Efficient Analytics in a Network Switch,” filed May 28, 2014, which is hereby incorporated by reference in its entirety. The overflow FIFO can be stored in SRAM. Alternatively, the overflow FIFO is fixed function hardware. The overflow FIFO is typically shared and used by all N counters.

The overflow FIFO stores the associated counter identifications of all counters that are overflowing. Typically, as soon as any of the N counters 105 starts overflowing, the associated counter identification of the overflowed counter is stored in the overflow FIFO 110. An interrupt is sent to a CPU to read the overflow FIFO 110 and the overflowed counter. After the overflowed counter is read, the overflowed counter is cleared or reset.

In a timing interval T, the number of counter overflow is M=ceiling(PPS*T/2^{w}), wherein PPS is packets per second, and w is the bit width of each counter. The total count of packets during interval T is PPS*T. Assume PPS is up to 654.8 MPPS, T=1, w=17 and N=16 k. Based on these assumptions, there are up to 4,995 overflow events per second.

The overflow FIFO is typically M-deep and log₂N-bits wide to capture all counter overflows. As such, the counter architecture 100 requires w*N+M*log₂N total storage bits, where M=ceiling(PPS*T/2^{w}).

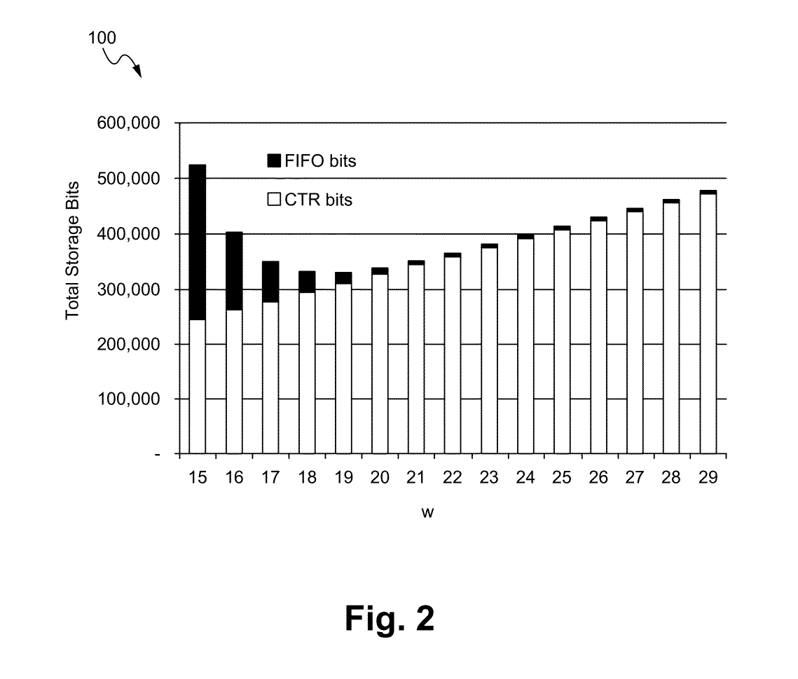

FIG. 2 illustrates an exemplary w-versus-total storage bits graph 200 of the general optimization problem. On the graph 200, w is represented on the x-axis, while total storage bits is represented on the y-axis. Assuming that the CPU reads and clears the overflow FIFO and the counters every second, the graph 200 shows a ratio between a total number of counter bits required and a total number of the FIFO bits required in the counter architecture 100 of FIG. 1 for each w, wherein w ranges from 15 to 29. The lighter shaded part of each bar indicates the number of counter bits required, while the darker shaded part of the bar indicates the number of FIFO bits required.

The graph 200 indicates that it is optimal for the counter architecture 100 to include counters that are 19-bits wide as the total storage bits required is the least. Taking, for example, the two lowest points, w=18 and w=19, in the graph 200, the total number of storage bits needed are approximately 329.882 kb (=18*16 k+(654.8 M/2¹⁸)*log₂16 k) and 328.781 kb (=19*16 k+(654.8 M/2¹⁹)*log₂16 k), respectively. As illustrated in FIG. 2, the counter architecture can be optimized by finding the minimum of w*N+M*log₂N, where M=ceiling(PPS*T/2^{w}), although tradeoffs regarding total storage bits, total number of FIFO bits and total number of counter bits can be made, depending on hardware requirements.

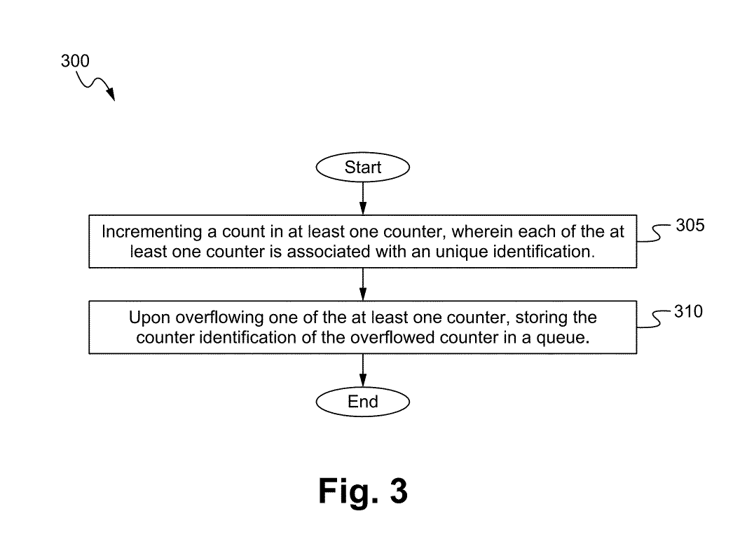

FIG. 3 illustrates a method 300 of a counter architecture, such as the counter architecture 100 of FIG. 1, according to an embodiment of the present invention. At a step 305, a count in at least one counter is incremented. As discussed above, each counter is associated with an unique identification. Typically, all counters are wrap-around counters and have the same width. For example, if w=17, then the largest value that each counter represents is 131,071. For another example, if w=18, then the largest value that each counter represents is 262,143. For yet another example, if w=19, then the largest value that each counter represents is 524,287. An overflow occurs when an arithmetic operation attempts to create a numeric value that is too large to be represented within an available counter.

At a step 310, upon overflowing one of the at least one counter, the counter identification of the overflowed counter is stored in a queue. In some embodiments, the queue is a FIFO buffer. The queue is typically shared and used by all counters in the counter architecture 100. In some embodiments, storing the counter identification in the queue sends an interrupt to the CPU to read values from the queue and the overflowed counter. It is possible to then calculate the actual value of the overflowed counter from the read values. After the overflowed counter is read by the CPU, the overflowed counter is typically cleared or reset.

For example, a counter with 5 as its counter identification is the first counter to overflow during arithmetic operations. The counter identification (i.e., 5) is then stored in the queue, presumably at the head of the queue since counter #5 is the first counter to overflow. In the meantime, the count in counter #5 can still be incremented. In the meantime, other counters can also overflow, with the counter identifications of those counters being stored in the queue.

An interrupt is sent to the CPU to read the value at the head of the queue (i.e., 5). The CPU reads the current value stored in the counter associated with the counter identification (i.e., counter #5). Since the counter width is known, the actual value of the counter can be calculated. Specifically, the actual value of the counter is 2^{w} plus the current value stored in the counter. Continuing with the example, assume the current value of counter #5 is 2 and w=17. The actual value of counter #5 is 131,074 (=2¹⁷+2). As long as the queue is not empty, the CPU continuously reads and clears the values from the queue and the counters.

The final total count of a particular counter is: the number of times the counter identification appears in the queue*2^{w} plus counter remainder value.

Although the counters have been described as for counting packets, it should be noted that the counters can be used for counting anything, such as bytes. Generally, an expected total count during T is calculated as EPS*T, where EPS is events per second. An upper bound of this maximum total count during time interval T can be established or calculated since the network switch is typically designed with a certain bandwidth from which the event rate can be calculated.

One of ordinary skill in the art will realize other uses and advantages also exist. While the invention has been described with reference to numerous specific details, one of ordinary skill in the art will recognize that the invention can be embodied in other specific forms without departing from the spirit of the invention. Thus, one of ordinary skill in the art will understand that the invention is not to be limited by the foregoing illustrative details, but rather is to be defined by the appended claims.

We claim:

1. A counter architecture implemented in a network device, the counter architecture comprises:
N wrap-around counters, wherein each of the N wrap-around counters is associated with a counter identification; and
an overflow FIFO used and shared by the N wrap-around counters, wherein the overflow FIFO stores the associated counter identifications of all counters that are overflowing.

2. The counter architecture of claim 1, wherein each of the N wrap-around counters is w-bits wide.

3. The counter architecture of claim 2, wherein the N wrap-around counters are in an on-chip SRAM memory.

4. The counter architecture of claim 1, further including at least one interrupt sent to a CPU to read the overflow FIFO and one of the overflowed counters.

5. The counter architecture of claim 1, wherein in a timing interval T, a number of counter overflow is M=ceiling(EPS*T/2^{w}), wherein EPS is events per second, and w is the bit width of each counter.

6. The counter architecture of claim 5, wherein EPS is packets per second for packet count.

7. The counter architecture of claim 5, wherein EPS is bytes per second for byte count.

8. The counter architecture of claim 5, wherein the overflow FIFO is M-deep and log₂N-bits wide to capture all counter overflows.

9. The counter architecture of claim 5, wherein the counter architecture requires w*N+M*log₂N total storage bits.

10. The counter architecture of claim 1, wherein the network device is a network switch.

11. A method of a counter architecture including at least one counter, the method comprising:
incrementing a count in the at least one counter, wherein the at least one counter is associated with a counter identification; and
upon overflowing the at least one counter, storing the counter identification of the overflowed counter in a queue.

12. The method of claim 11, wherein the at least one counter is a wrap-around counter.

13. The method of claim 11, wherein the queue is a FIFO buffer.

14. The method of claim 11, wherein storing the counter identification in the queue sends interrupt to a CPU to read values from the queue and the overflowed counter.

15. The method of claim 14, further comprising calculating an actual value of the overflowed counter from the read values.

16. The method of claim 14, further comprising, after reading the overflowed counter, clearing the overflowed counter.

17. A method of a counter architecture including a plurality of wrap-around counters, the method comprising:
incrementing counts in the plurality of wrap-around counters, wherein each of the plurality of counters is associated with a counter identification;
upon occurrence of an overflow of one of the plurality of wrap-around counters, storing the counter identification in an overflow FIFO;
processing data at the head of the overflow FIFO;
identifying a wrap-around counter by the data at the head of the overflow FIFO;
reading a value stored in the identified wrap-around counter; and
clearing the identified wrap-around counter.

18. The method of claim 17, wherein each of the plurality of wrap-around counters has the same width.

19. The method of claim 17, wherein the overflow FIFO is shared by the plurality of wrap-around counters.

20. The method of claim 17, wherein the counter architecture is implemented in a network device.

21. The method of claim 17, further comprising, as long as the overflow FIFO is not empty, repeating processing data, identifying a wrap-around counter, reading a value and clearing the identified wrap-around counter.

22. A network device comprising:
a common memory pool, wherein memories from the common memory pool are separated into a plurality of banks; and
a counter architecture for extending CPU read interval, wherein the counter architecture includes:
N wrap-around counters that use at least a subset of the plurality of banks, wherein each of the N wrap-around counters is associated with a counter identification; and
an overflow FIFO that stores associated counter identifications of all counters that wrap around.

23. The network device of claim 22, further comprising SRAM, wherein the N wrap-around counters are stored in SRAM.

24. The network device of claim 23, wherein the overflow FIFO is stored in SRAM.

25. The network device of claim 23, wherein the overflow FIFO is fixed function hardware.

26. The network device of claim 22, further including at least one interrupt sent to a CPU to read the overflow FIFO and to read and clear one of the N wrap-around counters.

27. The network device of claim 22, wherein in a timing interval T, a number of counter overflow is M=ceiling(total_count_during_interval_T/2^{w}), wherein total_count_during_interval_T is determined by bandwidth of the network device, and w is the bit width of each counter.

28. The network switch of claim 27, wherein the total_count_during_interval_T is PPS*T for packet count, wherein PPS is packets per second.

29. The network switch of claim 27, wherein the total_count_during_interval_T is BPS*T for byte count, wherein BPS is bytes per second.
